(19) United States
(12) Patent Application Publication
(10) Pub. No.: US 2025/0383768 A1
(43) Pub. Date: Dec. 18, 2025

(54) Vendor Specific Sub Block Access According to Sub Block Descriptor

(71) Applicant: Micron Technology, Inc., Boise, ID (US)

(72) Inventors: Pierre Labat, Campbell, CA (US); Luca Bert, Bologna (BO) (IT); Suresh Rajgopal, San Diego, CA (US)

(21) Appl. No.: 19/181,945

(22) Filed: Apr. 17, 2025

Related U.S. Application Data
(60) Provisional application No. 63/644,160, filed on May 8, 2024.

(51) Int. Cl. G06F 3/06

(52) U.S. Cl. CPC G06F 3/0608; G06F 3/064; G06F 3/0659; G06F 3/0679

(57) ABSTRACT

A memory sub-system, having: a host interface configured to operate on a computer bus; non-volatile memory cells; and a controller to store, in a vendor specific log page, data indicating that the memory sub-system supports sub block access and providing a sub block granularity level for the sub block access. After receiving, from the host system, an access command with a sub block descriptor configured to identify a portion of a logical block identified by the access command, the controller is to transfer, over the computer bus according to an opcode provided in the access command, data for the portion of the logical block without transferring over the computer bus data of the logical block outside of the portion of the logical block identified by the sub block descriptor.

### RELATED APPLICATIONS

The present application claims priority to Prov. U.S. Pat. App. Ser. No. 63/644, 160 filed May 8, 2024, the entire disclosures of which application are hereby incorporated herein by reference.

### TECHNICAL FIELD

At least some embodiments disclosed herein relate to memory systems in general, and more particularly, but not limited to memory systems operable to support access at block level and at sub block level.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a technique to facilitate sub block access via mapping namespaces configured in different communication protocols according to one embodiment.

FIG. 3 shows a memory sub-system configured with multiple ways to access a region of storage locations according to one embodiment.

FIG. 4 to FIG. 6 show methods for sub block access according to one embodiment.

FIG. 7 shows a technique to use a sub block descriptor according to one embodiment.

FIG. 8 shows an access command configured with a sub block descriptor according to one embodiment.

FIG. 9 shows the structure of a sub block descriptor according to one embodiment.

FIG. 10 to FIG. 13 show techniques to identify sub block granularity to a host system according to some embodiments.

FIG. 14 to FIG. 16 show methods for sub block access according to some embodiments.

FIG. 17 is a block diagram of an example computer system in which embodiments of the present disclosure can operate.

### DETAILED DESCRIPTION

At least some aspects of the present disclosure are directed to techniques to facilitate sub block access and block access to a memory sub-system. When the memory sub-system is accessed by a host system for read or write at a block level, the minimal size of data being transferred between the memory sub-system and the host system is the predefined size of a data block identified by a logical block addressing (LBA) address. When the memory sub-system is accessed by the host system for read or write at a sub block level, the data being transferred between the memory sub-system and the host system can have a size smaller than the predefined size of each data block identified by a respective logical block addressing (LBA) address.

A conventional memory sub-system (e.g., a solid-state drive in compliance with a non-volatile memory express (NVMe) standard) can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

Some memory sub-systems are configured to provide random memory accesses. A memory access protocol allows a host system to access the memory of such a memory sub-system using a memory address. Each memory address identifies a unit of memory (e.g., a byte) that has the storage capacity significantly smaller than the size of a block (e.g., 512 bytes) represented by a logical block address.

There can be a problem of read amplification over a computer bus (e.g., a peripheral component interconnect express (PCIe) bus) and memory amplification in a host system accessing a non-volatile memory sub-system, such as a block storage device implemented in according to a standard of non-volatile memory express (NVMe).

For example, in some classes of storage usages the data being accessed has a spatial locality (also known as the granularity of the data) that is smaller than the size of an NVMe logical block. Examples of such data of small spatial locality include graph structure and massive deep learning recommendation models (DLRMs). A graph structure is configured to identify each vertex in a graph via a list of vertices. In traversing the graph, certain vertices can be selectively accessed; and the size of data about each vertex can be smaller than the size (e.g., 512 bytes or more) of an NVMe logical block represented by each LBA address. Massive DLRMs can have many tables; and the majority of the tables used in inference computations can have embedding dimension smaller than 512 bytes.

Consider, for example, an NVMe logical block having a size of 4096 bytes, while the data to be used from this block has the size of 128 bytes. It is inefficient to move the block of 4096 bytes from a solid-state drive across a PCIe bus to the memory of the host system only to use 128 bytes of the block of 4096 bytes. The portion of the block outside of the 128 bytes being used only increases the memory usage in the host system. The block level access at 4096 bytes a block increases read amplification (e.g., data transferred over the PCIe bus being more than the data needed at the host system), and increases memory amplification (e.g., the amount of memory used for the read being more than the amount of useful data in the memory allocated for the read).

At least some techniques provided in the present disclosure address the above and other deficiencies and challenges by facilitating sub block read/write to transfer only the useful data contained within a portion of a block, without transferring the data of the block outside of the portion. Sub block access allows the host system to allocate its memory to hold the useful part of the data in a block (as opposed to allocate its memory for the entire block).

In one embodiment, sub block read and write can be performed using an NVMe memory namespace command set (e.g., as defined in NVMe TP4131), where read and write commands have a byte granularity. For example, when an NVMe block namespace is created, the NVMe controller in the solid-state drive can create and expose a companion NVMe memory namespace that has the same size of the NVMe block namespace and that uses the same storage resources (e.g., memory cells) as the NVMe block namespace.

Instead of mapping the companion NVMe memory namespace to a random access memory of the NVMe device, the NVMe controller of the device is configured to map the companion NVMe memory namespace to the logical storage space of the NVMe block namespace. The companion NVMe memory namespace allows the NVMe device to provide an alternative way to access the physical storage space used to implement the logical storage space of the NVMe block namespace.

Using the techniques of companion NVMe memory namespace, a same set of memory cells in the NVMe device can be accessed via read commands and write commands in two ways. One way is to use the NVMe command set on the NVMe block namespace at the granularity of NVMe logical block size. The other way is to use the NVMe command set on the NVMe memory namespace at the granularity of memory byte size.

To facilitate the two ways to access the NVMe device (e.g., via both the NVMe block namespace and its companion NVMe memory namespace), the NVMe device can be configured to have a fixed mapping between the memory namespace and the block namespace. When the NVMe controller receives a memory read or write command identifying the companion NVMe memory namespace, it converts the byte offset from the beginning of the memory namespace, as provided in the memory read or write command, into a logical block address defined in the NVMe block namespace (e.g., by dividing the offset by the logical block size). The logical block address can then be used to identify the storage resources (e.g., memory cells) allocated to implement the LBA block to perform the read or write operations.

For example, the NVMe device can be configured to perform a read operation to retrieve the data from the set of memory cells allocated as the storage resources of the LBA block. To execute a memory read command mapped to the LBA block, the NVMe device can select the portion of the data addressed by the offset specified in the memory read command, and transmit over the PCIe bus to the host system only the selected portion without transmitting the remaining portion of the LBA block. To execute a memory write command mapped to the LBA block, the NVMe device can be configured to perform a read merge write (RMW) operation, which modifies the portion of the retrieved data of the LBA block, as identified by the offset specified in the memory write command, and write to store a corresponding modified page (e.g., to a freshly allocated set of free memory cells to implement storage space of the page, or to the previously allocated memory cells for the page if the memory cells can be programmed to store new data without first erasing a block containing the page).

When a memory sub-system (e.g., an NVMe device) is configured to provide the two ways to access, a conventional host system can read/write the NVMe device using the NVMe block command set based on addressing in a block namespace, where the full LBA block of data is transmitted across the PCIe bus for read or write. A more advanced host system, when facing the data usage patterns of small granularity, can optionally use the memory namespace command set for sub block read and write to reduce read amplification and memory amplification.

The techniques of companion memory namespace have the advantages of being compatible with the NVMe specifications (e.g., NVMe base specification version 2.0 and NVMe TP4131). A sub block of an NVMe block can be transferred with reduced or minimized overhead. For example, the memory overhead in the host system for preparing and sending read commands and write commands to access a portion of a NVMe block can be reduced for small granularity data access. Further, the amount of overhead in data transmission over the PCIe bus between the host system and the NVMe device can be reduced for small granularity data access. Furthermore, the latency of executing commands to access data at small granularity can be reduced.

In some embodiments, a sub block identifier can be embedded in an access command (e.g., a read command, a write command) to access a portion of a block represented by an LBA address.

For example, a new type of scatter gather lists (SGL) descriptor can be defined and/or standardized to describe aspects of accessing a sub block. Such a sub block descriptor can be configured in a way similar to some of the SGL descriptors standardized in a version of NVMe standard (e.g., base specification version 2.0). However, such a sub block descriptor cannot be part of an SGL segment. Such a sub block descriptor can be specified in the data pointer (DPTR) field in an NVMe command. For example, according to NVMe base specification version 2.0, the field of data pointer (DPTR) has a size of 16 bytes configured in bytes 24 to 39 of an NVMe command.

For example, based on the information provided in the sub block descriptor, the NVMe device can identify and transfer, in response to a read command, a portion of the LBA block to the memory of the host system, without transferring the remaining portion of the LBA block and without the extra communications of fetching an SGL segment across a PCIe bus from the memory of the host system. In response to a write command, the NVMe device can transfer, from the memory of the host system based on the information provided in the sub block descriptor, the data to be written to a portion of the LBA block (e.g., for a read-modify-write operation within the NVMe device), without the host system providing the data for the remaining portion of the LBA block in the memory of the host system and without the extra communications of fetching an SGL segment across a PCIe bus from the memory of the host system.

The sub block descriptor can have a plurality of pre-defined fields to specify an address in the memory of the host system, an offset in an LBA block, and a length for a portion selected from the LBA block. The offset and the length identifies the location of the portion to be accessed within the LBA block; and the address identifies the location in the memory of the host system where the data being extracted from the LBA block data is to be stored according to the read command, or where the data being written according to the write command is provided by the host system.

An NVMe device can be configured to communicate to host systems the sub block granularity it supports. The sub block granularity can be a number of bytes as a power of 2, and smaller than the storage capacity of each logical block in the NVMe device.

The length as specified in the sub block descriptor for a read or write command can be based on the sub block granularity. For example, the size of data being access via the sub block descriptor can be a number of bytes equal to the length, as a number provided in the sub block descriptor, multiplied by the sub block granularity.

Further, the offset as specified in the sub block descriptor can also be in the unit of bytes represented by the sub block granularity. For example, the size of the offset portion (from the beginning of the logical block to the portion selected by the sub block descriptor) can be a number of bytes equal to the offset, as a number provided in the sub block descriptor, multiplied by the sub block granularity.

According to a version of NVMe standard (e.g., base specification version 2.0), bits 22 to 31 in the field “SGL support” in the “identify controller data structure, I/O command set independent” are reserved. To extend the standard with backward compatibility, bit 22 of the field “SGL Support” can be used to indicate whether a sub block descriptor is supported; and bits 23 to 26 can be used to identify the sub block granularity. For example, when a number n is specified in bits 23 to 26, the sub block granularity is 2\hat{ }n.

For example, the sub block descriptor can be configured to have a predetermined size of 16 bytes (e.g., the same size as a “SGL data block descriptor” in a version of NVMe standard, such as NVMe base specification version 2.0). Bytes 0 to 7 can be configured to specify the address in the memory of the host system; bytes 8 to 10 can be configured to specify the length; bytes 11 to 14 can be configured to specify the offset; and byte 15 can be configured to specify a type and a sub type.

According to a version of NVMe standard (e.g., base specification version 2.0), SGL descriptor types 6 h to Eh are reserved. To extend the standard with backward compatibility, a predetermined value selected from 6 h to Eh can be used to represent the type of the sub block descriptor. For example, the type of the sub block descriptor can be configured to be represented by a predetermined value of 6 h.

The sub type of the sub block descriptor can be configured to have the same meaning as the sub type of “SGL Data Block descriptor” in a version of NVMe standard (e.g., base specification version 2.0). For example, when the sub type has the value of Oh, the address provided in the sub block descriptor is considered the starting 64-bit memory byte address; and when the sub type has the value of 1 h, the address provided in the sub block descriptor is considered to include an offset from the beginning of the location where data may be transferred.

When a version of NVMe standard (e.g., base specification version 2.0) is extended to allow the use of the sub block descriptor as discussed herein, an NVMe device in compliance with the standard can provide sub block access with a minimal overhead, because the information used to select a sub block from an LBA block is embedded within an NVMe command itself.

Optionally, the sub block descriptor and its usage can be implemented as a vendor specific feature/extension that is in compliance with and is compatible with a current version of NVMe standard (e.g., base specification 2.0) that does not specify features related to sub block descriptor.

When the techniques of the sub block descriptor are implemented as a vendor specific feature/extension, an NVMe device can be configured to provide the sub block granularity it supports via vendor specific communications, such as the vendor specific log page provided in a way as specified in the NVMe standard (e.g., base specification 2.0).

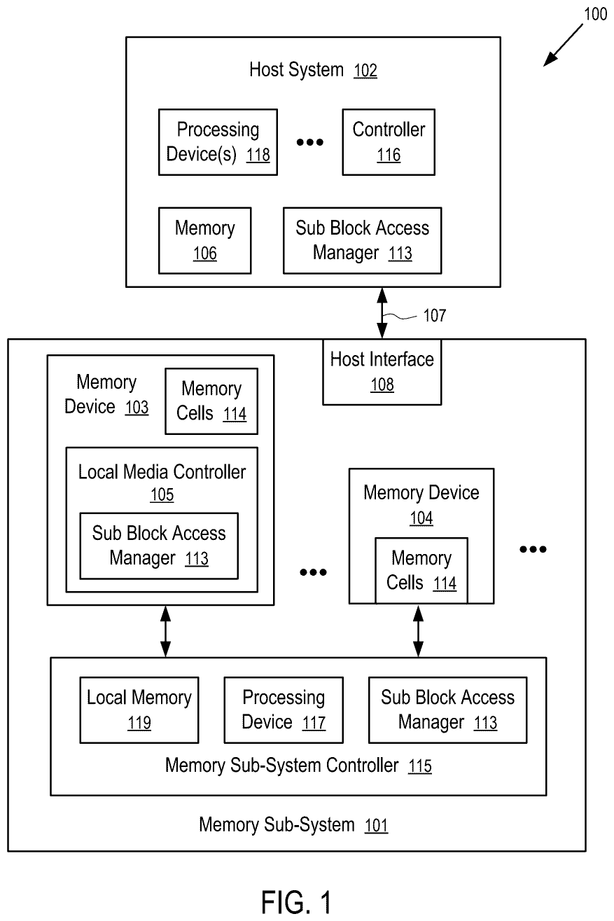

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a sub block access manager 113 configured to perform operations related to accessing the memory sub-system 101 at a granularity level lower than the size of an LBA block. In some embodiments, the controller 115 in the memory sub-system 101 includes at least a portion of the sub block access manager 113. In other embodiments, or in combination, the controller 116 and/or the processing device 118 in the host system 102 includes at least a portion of the sub block access manager 113. For example, the controller 115, the controller 116, and/or the processing device 118 can include logic circuitry implementing the sub block access manager 113. For example, the controller 115, or the processing device 118 (processor) of the host system 102, can be configured to execute instructions stored in memory for performing the operations of the sub block access manager 113 described herein. In some embodiments, the sub block access manager 113 is implemented in an integrated circuit chip disposed in the memory sub-system 101. In other embodiments, the sub block access manager 113 can be part of firmware of the memory sub-system 101, an operating system of the host system 102, a device driver, or an application, or any combination therein.

For example, the sub block access manager 113 implemented in the controller 115 and/or 105 of the memory sub-system 101 can be configured to create and expose a companion memory namespace for a block namespace. The block namespace is configured to provide data access at a first granularity level (e.g., an LBA block size of 512 bytes or more); and the memory namespace is configured to provide data access at a second granularity level (e.g., a memory chunk size of less than 512 bytes, such as a byte, or 128 bytes). The access to memory locations in the companion memory namespace is configured to be performed based on the mapping between logical block addresses defined in the block namespace and physical memory addresses of storage resources (e.g., memory cells 114) in the memory devices (e.g., 103, . . . , 104) of the memory sub-system 101.

For example, the sub block access managers 113 in the host system 102 and the memory sub-system 101 can be configured to implement the techniques of sub block descriptor, including communications to identify supports for sub block descriptor, determine sub block granularity in the memory sub-system 101, forming and providing sub block descriptors in access commands, and processing sub block descriptors embedded in access commands to facilitate transfer of data at sub block levels.

Further details of the operations of the sub block access managers 113 in the host system 102 and in the memory sub-system 101 are discussed below.

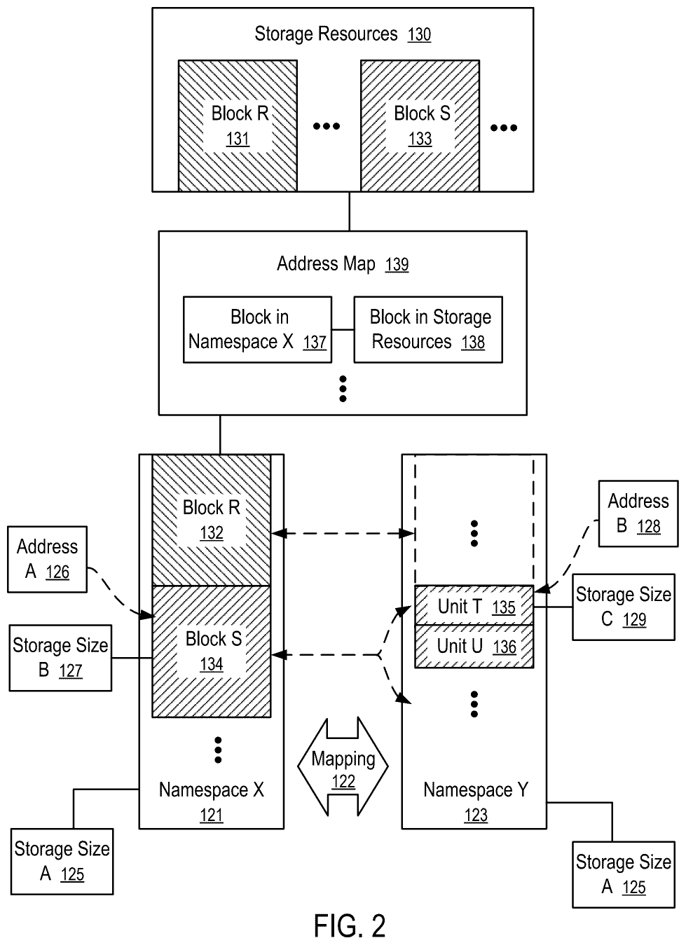

FIG. 2 shows a technique to facilitate sub block access via mapping namespaces configured in different communication protocols according to one embodiment. For example, the technique of FIG. 2 can be implemented in the computing system 100 of FIG. 1.

In FIG. 2, the sub block access managers 113 in the host system 102 and in the memory sub-system 101 are configured to establish two namespaces 121 and 123 having different data access granularity levels.

For example, the namespace 121 can be an NVMe block namespace; and the namespace 123 can be an NVMe memory namespace.

The smallest unit of storage space accessible in the namespace 121 is a block (e.g., 132 or 134) represented by a respective address (e.g., 126) defined in the namespace 121 to represent the block (e.g., 134). The smallest unit of storage space accessible in the namespace 121 can be considered the access granularity of the namespace 121. For example, the storage size 127 of a block 134 (and thus the access granularity of the namespace 121) can be 512 bytes or more (e.g., 4096 bytes).

The smallest unit of storage space accessible in the namespace 123 is a unit (e.g., 135 or 136) represented by a respective address (e.g., 128) defined in the namespace 123 to represent the unit (e.g., 136). The smallest unit of storage space accessible in the namespace 123 can be considered the access granularity of the namespace 123. For example, the storage size 129 of a unit 135 (and thus the access granularity of the namespace 123) can be a fraction of the size 127.

The namespaces 121 and 123 have the same total storage size 125. Further, the namespaces 121 and 123 are configured to overlap with each other to represent a same set of physical storage resources (e.g., blocks 131, . . . , 133) allocated to implement the physical storage space represented by the namespace 121 (and by the namespace 123).

The memory sub-system 101 is configured to establish a predetermined mapping between the addresses (e.g., 126) in the namespace 121 having a larger storage granularity level represented by the size 127, and the addresses (e.g., 128) in the namespace 123 having a smaller storage granularity level represented by the size 129.

For example, each block (e.g., 134) in the namespace 121 can be configured to contain a predetermined number of units (e.g., 135, 136, . . . ) in the namespace 123. For example, the block (e.g., 134) represented by the address 126 in the namespace 121 and containing a unit 135 in the namespace 123 can be configured to be determined from dividing the address 128 (e.g., specified as a memory offset in the namespace 123 from the beginning of the namespace 123) by the ratio between the sizes 127 and 129. Thus, it is not necessary to store further data for the mapping 122 between the namespaces 121 and 123.

The memory sub-system 101 can be configured to store an address map 139 to map between the blocks (e.g., 132, 134) in the namespace 121 and corresponding blocks (e.g., 131, 133) among the physical storage resources 130 (e.g., memory cells 141) allocated as storage media to implement storage spaces of the blocks (e.g., 132, 134).

For example, the address map 139 can include data associating an identification of a logical block 137 in the namespace 121 and an identification of a block 138 in the storage resources 130 (e.g., memory cells 114) allocated as the media of the logical block 137. For example, the logical block 137 can be the block 132 having an address 125 in the namespace 121; and the storage resource block 138 can be the block 131 allocated for the logical block 132.

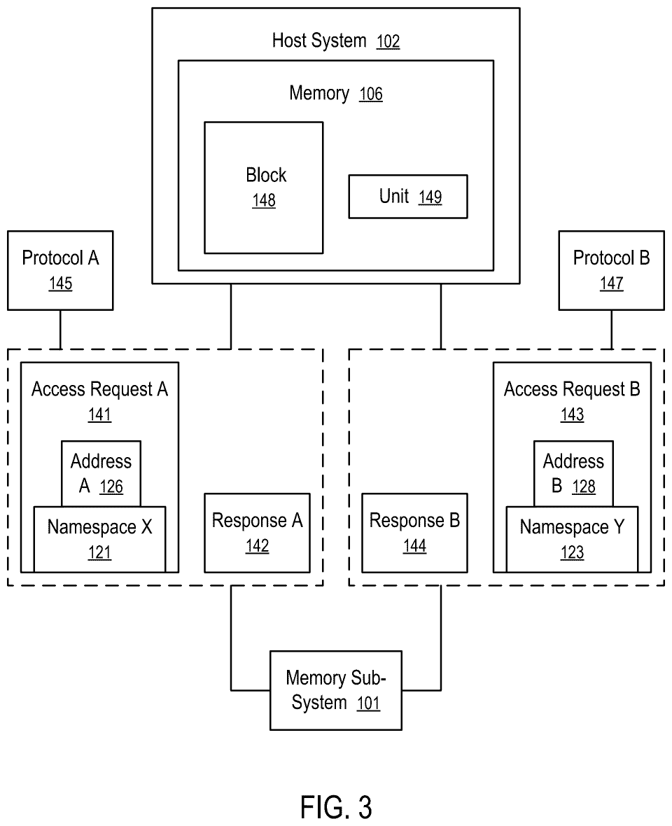

The mappings (e.g., address map 139 and mapping 122) as illustrated in FIG. 2 allow the host system 102 to access storage resources 130 at different granularity levels represented by the sizes 127 and 129, as further discussed in connection with FIG. 3.

FIG. 3 shows a memory sub-system configured with multiple ways to access a region of storage locations according to one embodiment. For example, the different ways of access can be implemented in the computing system 100 of FIG. 1 and using the technique of FIG. 2.

In FIG. 3, the host system 102 can use a protocol 145 (e.g., a NVMe block command set) to send an access request (e.g., 141) directed to the address 126 in the namespace 121; and the memory sub-system 101 can provide a corresponding response (e.g., 142) using the protocol 145.

For example, the access request 141 can be a read command. The memory sub-system 101 can execute the read command by using the address map 139 to determine the storage resource block 133 (e.g., as in FIG. 2) allocated to implement the logical block 134 having the address 126 defined in the namespace 121. The memory sub-system 101 then retrieves the data block 148 from the storage resource block 133, and sends the data block 148 across the computer bus 107 to the memory 106 of the host system 102, as instructed by the access request 141 according to the protocol 145.

For example, the access request 141 can be a write command. The memory sub-system 101 can use the address map 139 to determine the storage resource block 133 allocated to implement the logical block 134 having the address 126 defined in the namespace 121. After retrieving the data block 148 from the memory 106 of the host system 102, as instructed by the access request 141 according to the protocol 145, the memory sub-system 101 can program the storage resource block 133 to store the data block 148 obtained from the memory 106 of the host system 102.

When the host system 102 determines that only a unit 149 within the block 148 is to be used or stored, the host system 102 can use another protocol 147 (e.g., a NVMe memory command set) to send an access request (e.g., 143) directed to the address 128 in the namespace 123; and the memory sub-system 101 can provide a corresponding response (e.g., 144) using the protocol 147.

For example, the access request 143 can be a read command. The memory sub-system 101 can execute the read command by determining, based on the mapping 122, the address 126 in the namespace 121 representing a block 134 containing the unit 135 represented by the address 128 in the namespace 123. Then, the memory sub-system 101 uses the address map 139 to determine the storage resource block 133 allocated to implement the logical block 134 having the address 126 determined from the mapping 122. After retrieving the data block (e.g., 148) from the storage resource block 133, the memory sub-system extracts the data unit 149 based on the mapping 122, and sends only the data unit 149 across the computer bus 107 to the memory 106 of the host system 102, without sending the remaining portion of the data block (e.g., 148) outside of the unit 149.

For example, the access request 143 can be a write command. The memory sub-system 101 can execute the write command via a read-modify-write operation. The memory sub-system 101 determines the address 126 in the namespace 121 representing a block 134 containing the unit 135 represented by the address 128 in the namespace 123. Then, the memory sub-system 101 uses the address map 139 to determine the storage resource block 133 allocated to implement the logical block 134 having the address 126 determined from the mapping 122. After retrieving the data block (e.g., 148) from the storage resource block 133, the memory sub-system modifies the data block (e.g., 148) using the data unit 149 retrieved from the memory 106 of the host system 102. The data unit 149 is used to overwrite the corresponding portion in the data block (e.g., 148) to generate a modified data block, as instructed by the access request 143 according to the protocol 145. The memory sub-system 101 then programs the storage resource block 133 (or another storage resource block allocated as the media of the storage space represented by the address 126 in the namespace 121) to store the modified data block.

Thus, the sub block access manager 113 in the host system 102 can be configured to selectively use one of the protocols 145 and 147 to access the memory sub-system 101, according to the data spatial locality in an application, to reduce memory amplification, to reduce read amplification, and/or to latency in storage access.

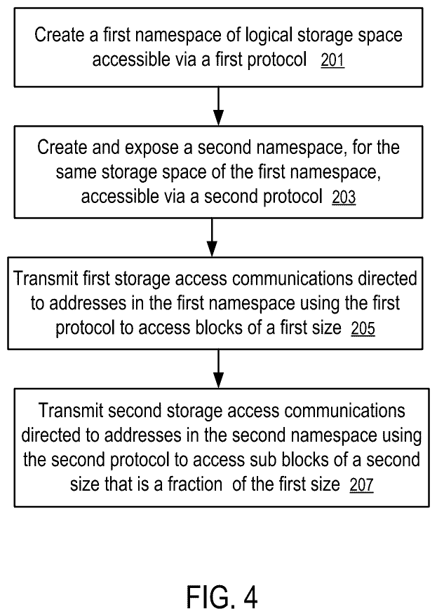

FIG. 4 to FIG. 6 show methods for sub block access according to one embodiment. The methods of FIG. 4 to FIG. 6 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 4 to FIG. 6 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 4 to FIG. 6 can be implemented using the sub block access managers 113 of FIG. 1 to perform the operations illustrated in FIG. 2 to FIG. 3.

At block 201 in FIG. 4, the memory sub-system 101 creates a first namespace (e.g., 121) of logical storage space accessible via a first protocol (e.g., 145) (e.g., in response to a request or command from the host system 102).

At block 203, the memory sub-system 101 creates and exposes a second namespace (e.g., 123), for the same storage space of the first namespace (e.g., 121), accessible via a second protocol (e.g., 147) (e.g., automatically in response to a request to create the first namespace (e.g., 121), or in response to a separate request or command from the host system 102).

At block 205, the memory sub-system 101 and/or the host system 102 can transmit first storage access communications (e.g., request 141 and response 142) directed to addresses (e.g., 126) in the first namespace (e.g., 121) using the first protocol (e.g., 145) to access blocks (e.g., 134) of a first size (e.g., 127).

At block 207, the memory sub-system 101 and/or the host system 102 can transmit second storage access communications (e.g., request 143 and response 144) directed to addresses (e.g., 128) in the second namespace (e.g., 123) using the second protocol (e.g., 147) to access sub blocks (e.g., unit 135) of a second size (e.g., 129) that is a fraction of the first size (e.g., 107).

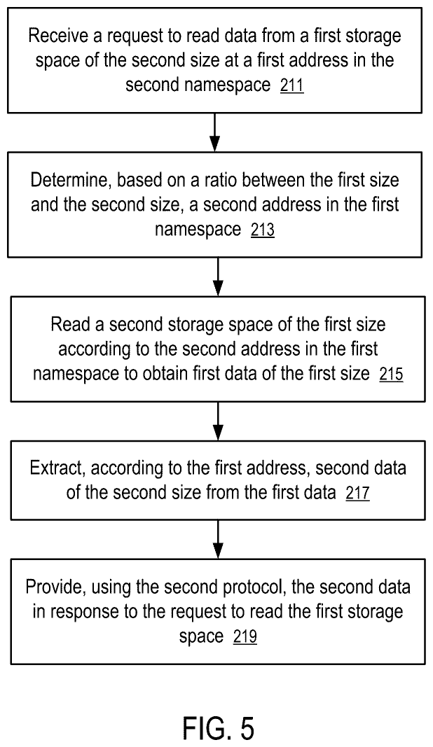

For example, the second storage access communications (e.g., request 143) can include a request 143 to read data from a sub block (e.g., unit 135); and the request 143 to read can be processed by the memory sub-system 101 using the method of FIG. 5.

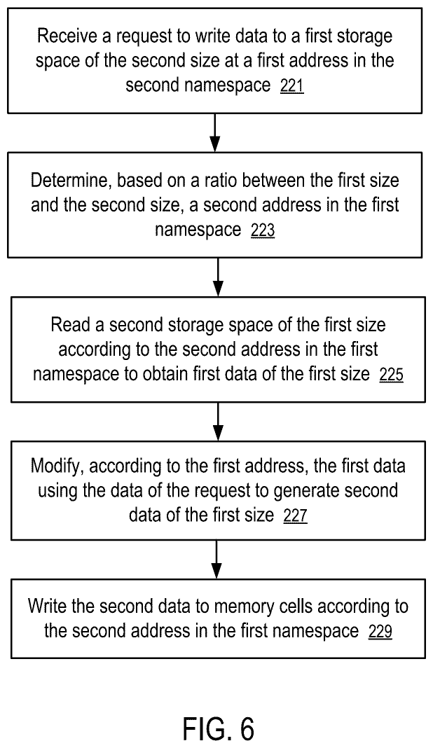

For example, the second storage access communications (e.g., request 143) can include a request 143 to write data to a sub block (e.g., unit 135); and the request 143 can be processed by the memory sub-system 101 using the method of FIG. 6.

At block 211 in FIG. 5, the memory sub-system 101 receives, a request 143 to read data from a first storage space (e.g., unit 135) of the second size (e.g., 129) at a first address (e.g., 128) in the second namespace (e.g., 123).

At block 213, the memory sub-system 101 determines, based on a ratio between the first size (e.g., 127) and the second size (e.g., 129), a second address (e.g., 126) in the first namespace (e.g., 121).

At block 215, the memory sub-system 101 reads a second storage space (e.g., block 134) of the first size (e.g., 126) according to the second address (e.g., 126) in the first namespace (e.g., 121) to obtain first data (e.g., data block 148) of the first size (e.g., 127).

At block 217, the memory sub-system 101 extracts, according to the first address (e.g., 128 as being mapped to the second storage space by the mapping 122), second data (e.g., data unit 149) of the second size (e.g., 129) from the first data (e.g., data block 148). At block 219, the memory sub-system 101 provides, using the second protocol (e.g., 147), the second data (e.g., data unit 149) in response to the request 143 to read the first storage space (e.g., unit 135). For example, the memory sub-system 101 provides, over a computer bus 107 (e.g., PCIe bus) connected between the memory 106 of the host system 102 and the host interface 108 of the memory sub-system 101, the second data (e.g., data unit 149) to the memory 106 in the host system 102, without providing the remaining portion of the first data (e.g., data block 148).

At block 221 in FIG. 6, the memory sub-system 101 receives a request 143 to write data (e.g., data unit 149) from a first storage space (e.g., unit 135) of the second size (e.g., 129) at a first address (e.g., 128) in the second namespace (e.g., 123).

At block 223, the memory sub-system 101 determines, based on a ratio between the first size (e.g., 127) and the second size (e.g., 129), a second address (e.g., 126) in the first namespace (e.g., 121).

At block 225, the memory sub-system 101 reads a second storage space (e.g., block 134) of the first size (e.g., 126) according to the second address (e.g., 126) in the first namespace (e.g., 121) to obtain first data (e.g., data block 148) of the first size (e.g., 127).

At block 227, the memory sub-system 101 modifies, according to the first address (e.g., 128), the first data (e.g., data block 148) using the data (e.g., data unit 149) of the request 143 to generate second data (e.g., a modified version of the data block 148) of the first size (e.g., 127).

For example, the data (e.g., data unit 149) of the request 143 is provided by the host system 102 in the memory 106 at a location identified by the request. 143. The retrieval and the modification of the data block 148 is performed within the memory sub-system 101 without transmitting the data block 148 over the computer bus 107 coupled between the memory 106 of the host system 102 and the host interface 108 of the memory sub-system 101.

Since the request 143 to write data is for the data unit 149, the host system 102 does not have to allocate, for the request 143, memory of the size of the entire data block 148. Providing the data unit 149 in the memory 106 of the host system 102 is sufficient for the request 143.

At block 229, the memory sub-system 101 writes the second data (e.g., the modified version of the data block 148) to memory cells 114 in the memory sub-system 101 according to the second address (e.g., 126) in the first namespace (e.g., 121).

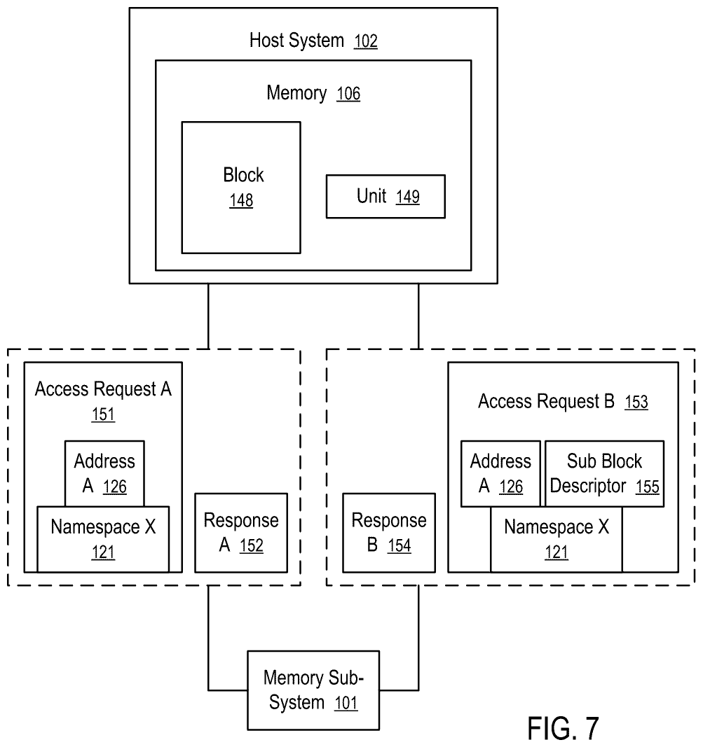

FIG. 7 shows a technique to use a sub block descriptor according to one embodiment. For example, the technique of FIG. 7 can be implemented in the computing system 100 of FIG. 1 and optionally used in combination with techniques of FIG. 2 to FIG. 6.

In FIG. 7, the host system 102 can access the storage space in the memory sub-system 101 at the granularity level of a predefined logical block size (e.g., 512 bytes, or larger) using a protocol (e.g., 145, such as a protocol according to a version of NVMe standard). Using the protocol 145, the host system 102 can send an access request 151 identifying an address configured according to the granularity level of the predefined logical block size (e.g., 127) in a namespace 121. The memory sub-system 101 can provide a response 152 to the request 151 (e.g., to read data from memory cells 114 in the memory sub-system 102 to the memory 106 of the host system 102, or to write data to memory cells 114 in the memory sub-system 102 from the memory 106 of the host system 102).

To facilitate the access to the storage space in the memory sub-system 101 at a granularity level of a storage size (e.g., 128) that is smaller than the predefined logical block size 127, the access request 151 can be modified to carry an embedded sub block descriptor 155 to identify a sub block based on the logical block identified via the address 126.

For example, the access request 151 at a block level can be modified to include a sub block descriptor 170 to provide the access request 153 at a sub block level. The access request 153 at the sub block level and the access request 151 at the block level can be configured to have exactly the same size by specifying the sub block descriptor 155 in an existing field specified by the protocol 145, such as a field of data pointer of an NVMe standard. The support for the use of the sub block descriptor 170 in the field can be configured to be compatible with the protocol 145 such that the host system 102 can send the access requests 151 and 153 to obtain respective responses 152 and 154 in accessing at the block level and the sub block level respectively. Optionally, the techniques of the sub block descriptor 155 are standardized as an enhanced version of NVMe standard (e.g., base specification version higher than 2.0). Alternatively, the techniques of the sub block descriptor 155 can be implemented as a vendor specific feature/enhancement that is in compliance with a version of NVMe standard (e.g., base specification version 2.0).

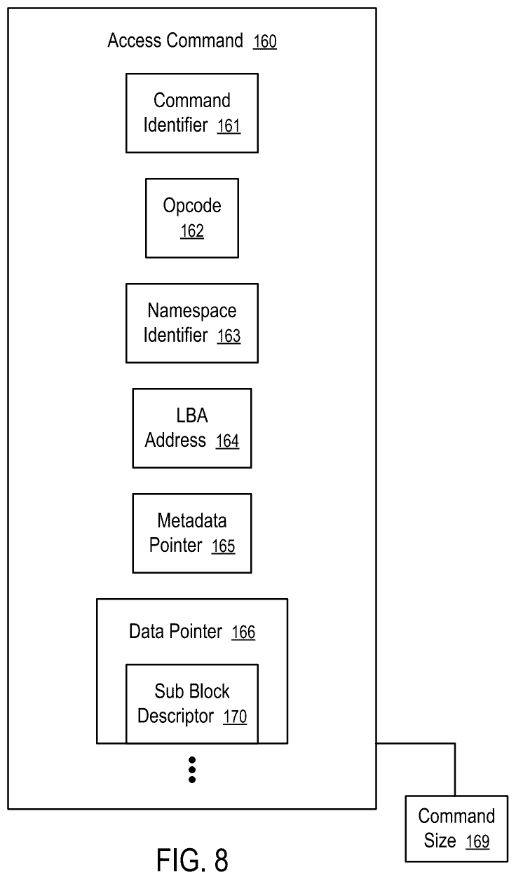

FIG. 8 shows an access command configured with a sub block descriptor according to one embodiment. For example, the access request 153 of FIG. 7 can be implemented according to the access command 160 of FIG. 8.

In FIG. 8, the access command 160 can have a predetermined command size 169 (e.g., 64 bytes according to a version of NVMe standard). Thus, the use of the sub block descriptor 170 does not increase the overhead in communications between the host system 102 and the memory sub-system 101.

When the sub block descriptor 170 is not specified in the access command 160 (and/or replaced with another descriptor standardized in the protocol 145, such as NVMe base specification version 2.0), the access command 160 can become an access request 151 at the block level.

The access command 160 can have a plurality of predefined fields, such as command identifier 161, opcode 162, namespace identifier 163, LBA address 164, metadata pointer 165, data pointer 166, etc.

For example, predefined fields can be in compliance with a version of NVMe standard (e.g., base specification version 2.0). Command identifier 161 can be configured to specify an identifier of the command 160 such that the identifier is to uniquely identify the command 160 among commands currently provided by the host system 102 to the memory sub-system 101 for execution. The opcode 162 can be configured to specify whether the command 160 is to be executed to read data or to write data (or another operation). The namespace identifier 163 can be configured to specify the namespace 121 for the interpretation of the LBA address 164. The LBA address 164 identifies, in the namespace 121, a logical block having the predefined logical block size (e.g., 512 bytes, or larger). The metadata point 165 can be configured to provide an address of physical buffer of metadata or an address for an SGL segment. The data pointer 166 can be configured to provide an entry used for data transfer, such as an entry to facilitate data transfer via physical region page (PRP) or via scatter gather lists (SGL).

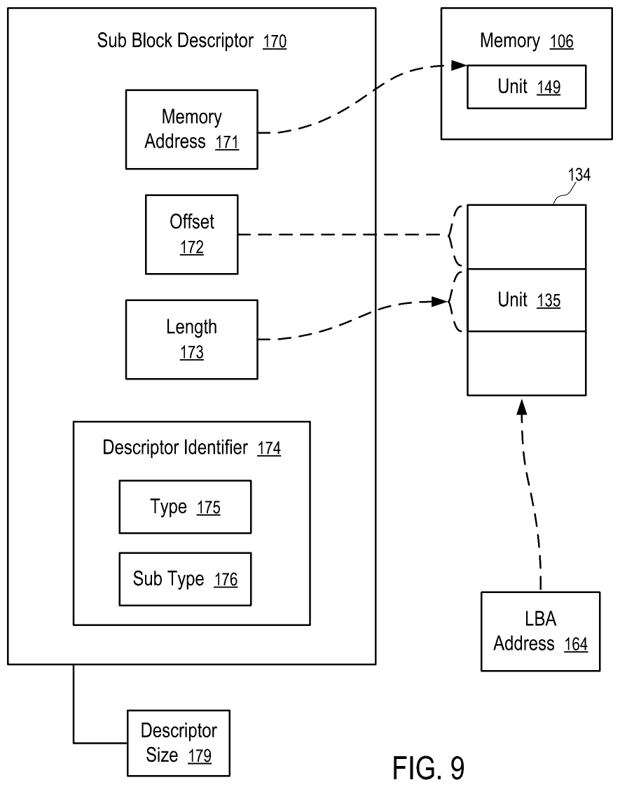

The sub block descriptor 170 can be configured in a way similar to the provision of an entry for data transfer via scatter gather lists (SGL). For example, sub block descriptor 170 can be configured according to a generic SGL descriptor format according to a version of NVMe standard (e.g., base specification version 2.0), as illustrated in FIG. 9.

FIG. 9 shows the structure of a sub block descriptor according to one embodiment. For example, the sub block descriptor 170 of FIG. 9 can be used in the access command 160 of FIG. 8.

In FIG. 9, the sub block descriptor 170 has a predetermined size 179 (e.g., 16 bytes in accordance with the generic SGL descriptor format specified in NVMe base specification version 2.0).

The sub block descriptor 170 has a field for descriptor identifier 174 (e.g., byte 15 in accordance with the generic SGL descriptor format specified in NVMe base specification version 2.0). The descriptor identifier 174 can specify a type 175 and a sub type 176 for the sub block descriptor 170. For example, the type 175 can be specified in bits 4 to 7 of the field, and the sub type 176 in bits 0 to 7 of the field according to generic SGL descriptor format specified in NVMe base specification version 2.0.

The value of the type 175 for the sub block descriptor 170 can be predetermined and different from other SGL descriptor types. For example, NVMe base specification version 2.0 assigns values 0 h to 5 h to certain types of SGL descriptors, such as SGL data block descriptor, SGL bit bucket descriptor, SGL segment descriptor, SGL last segment descriptor, keyed SGL data block descriptor, and transport SGL data block descriptor. Type values 6 h to Eh are reserved; and type value Fh is vendor specific in NVMe base specification version 2.0. Thus, the predetermined value (e.g., 6 h) of the type 175 can be selected from 6 h to Eh for the sub block descriptor 170 without conflicts with the NVMe base specification version 2.0.

The meanings of possible values of the sub type 176 for the sub block descriptor 170 can be configured in a way same as the sub type of SGL data block descriptor defined in the NVMe base specification version 2.0. For example, a value of 0 h specified for the sub type 176 can be used to indicate that the field of memory address 171 is used to provide the starting 64-bit memory byte address of the data block; and a value of 1 h for the sub type 176 can be used to indicate that the field of memory address 171 contains an offset from the beginning of the location where data may be transferred.

The sub block descriptor 170 has a field for memory address 171 (e.g., byte 0 to byte 7 of the sub block descriptor 170). The memory address 171 identifies the location of a data unit 149 within the memory 106 of the host system 102. In a read operation, a data unit 149 as retrieved from the memory sub-system 102 is to be stored according to the memory address 171 as a response to the access request 160 having an opcode 162 for read. In a write operation, a data unit 149 is obtained from the memory 106 according to the memory address 171 for writing into the memory sub-system 102 as a response to the access request 160 having an opcode 162 for write.

The sub block descriptor 170 has a field for offset 172 (e.g., byte 11 to byte 14 of the sub block descriptor 170) to identify a location of the logical space unit 135 within the logical block 134 represented by the LBA address 164 specified in the access command 160 that contains the sub block descriptor 170.

The sub block descriptor 170 has a field for length 173 (e.g., byte 8 to byte 10 of the sub block descriptor 170) to identify a size of the logical space unit 135 within the logical block 134 represented by the LBA address 164 specified in the access command 160 that contains the sub block descriptor 170.

Thus, when the access command 160 contains the sub block descriptor 170 and an opcode 162 for read, the memory sub-system 101 can obtain the data unit 149 from the logical space unit 135 within the logical block 134 based on the LBA address 164 specified in the access command 160, the offset 172, and the length 173 specified in the sub block descriptor 170; and the memory sub-system 101 then provides the data block 149 to the memory 106 of the host system 102 at the location specified by the memory address 171.

Thus, when the access command 160 contains the sub block descriptor 170 and an opcode 162 for write, the memory sub-system 101 can obtain the data block 149 from the memory 106 of the host system 102 at the location specified by the memory address 171, and write the data block 149 to logical space unit 135 within the logical block 134 based on the LBA address 164 specified in the access command 160, the offset 172 and the length 173 specified in the sub block descriptor 170. For example, writing the data block 149 can be performed via a read-modify-write operation. In the read-modify-write operation, the data block stored at the logical block 134 is read; the portion of the data block at the unit 135 is replaced with the data block 149 to generate a modified data block; and a write operation is performed to store the modified data block in the memory sub-system 101 at the logical block 134 represented by the LBA address 164.

The offset 172 and length 173 can be configured to identify the location and size of the unit 135 within the block 134 based on a granularity level of sub block support in the memory sub system 101. For example, the granularity level of sub block support can be specified as a minimal size of a unit 135 that can be retrieved via the use of a sub block descriptor (e.g., 170). The length 173 is specified as a number such that the size of the unit 135 is the minimal size multiplied by the number. Similarly, the offset 172 is specified as a number such that the size of the space above the unit 135 in the logical block 134 is the minimal size multiplied by the number.

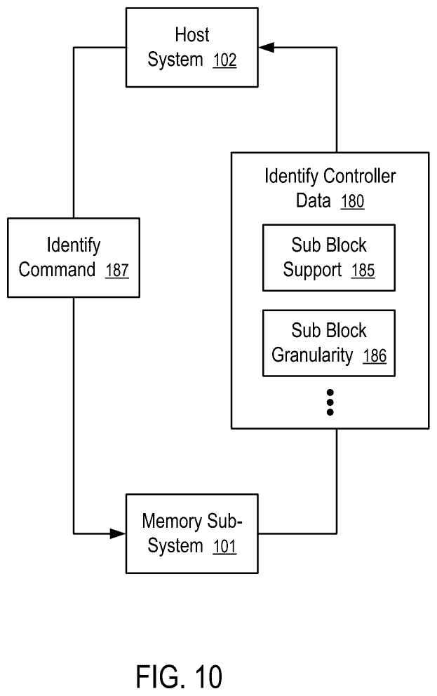

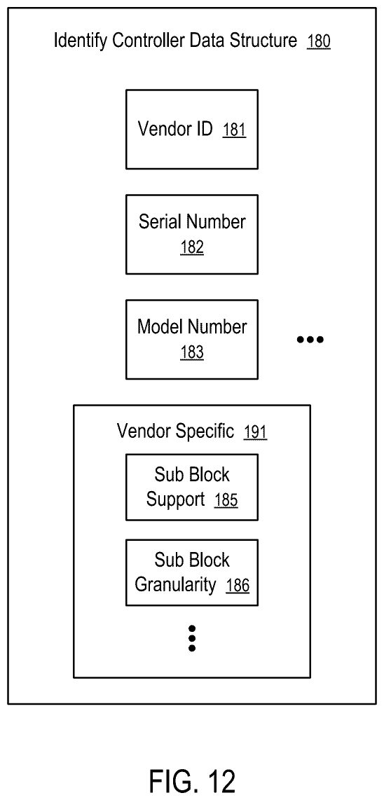

The memory sub-system 101 can be configured to notify (e.g., using the techniques of FIG. 10 to FIG. 13) a host system (e.g., 102) of whether the memory sub-system 101 supports the use of a sub block descriptor 170 and if so, the granularity level of sub block support.

FIG. 10 to FIG. 13 show techniques to identify sub block granularity to a host system according to some embodiments.

In FIG. 10, the host system 102 can send an identify command 187 to receive identify controller data 180 from the memory sub-system 101. For example, the identify command 187 and the identify controller data 180 can be in accordance with NVMe base specification version 2.0.

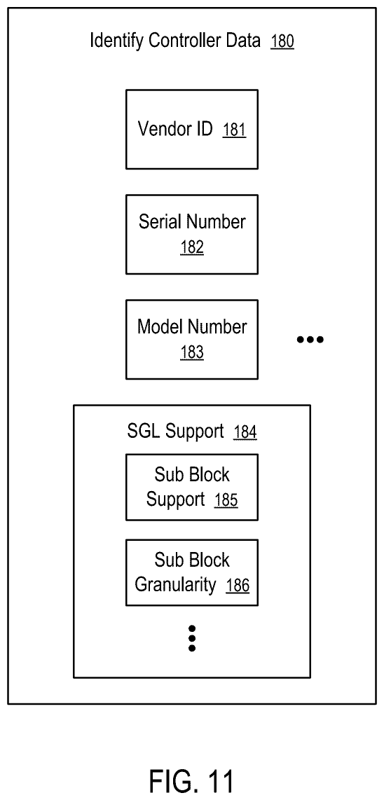

For example, the identify controller data 180 in FIG. 11 can include a plurality of predefined fields in accordance with NVMe base specification version 2.0. Such fields can include a field of vendor ID 181, a field of serial number 182 of the memory sub-system 102, a field of model number 183 of the memory sub-system 102, a field of indication of SGL support 184. Sub block support 185 and sub block granularity 186 can be specified using portions of the SGL support 184.

According to NVMe base specification version 2.0, bit 22 to bit 31 of the field of SGL support (SGLS) in “identify controller data structure, I/O command set independent” are reserved. Thus, bit 22 of the field of SGL support (SGLS) can be used to specify sub block support 185; and bit 23 to 26 can be used to specify sub block granularity 186, without conflicts or incompatibility with NVMe base specification version 2.0.

For example, a value of zero for the sub block support 185 can be used to indicate that the memory sub-system 101 does not support sub block descriptor (e.g., 170); and in response, the host system 102 does not send, to the memory sub-system 101, any access command (e.g., 160) that contains a sub block descriptor (e.g., 170). A value of one for the sub block support 185 can be used to indicate that the memory sub-system 101 supports the use of sub block descriptor (e.g., 170) at the specified granularity 186. With the knowledge about the sub block support 185 and granularity 186, the host system 102 can optionally send, to the memory sub-system 101, an access command (e.g., 160) containing a sub block descriptor (e.g., 170) to access the storage space in the memory sub-system 101 at a sub block level.

For example, when the sub block granularity 186 is specified as a number n in the identify controller data 180, the minimal size of a sub block that can be specified via a length 173 in a sub block descriptor 170 is 2\hat{ }n. Thus, the host system 102 can compute the offset 172 and the length 173 used in the sub block descriptor 170 for accessing a storage unit 135 based on the sub block granularity 186 identified in the identify controller data 180.

Alternatively, when the support for sub block descriptor is implemented as a vendor specific feature/enhancement of a device in compliance with a version of NVMe standard (e.g., base specification version 2.0), the sub block support 185 and the sub block granularity 186 can be configured in the field of vendor specific 191 (e.g., between byte 3072 and byte 4095) in the identify controller data structure 180.

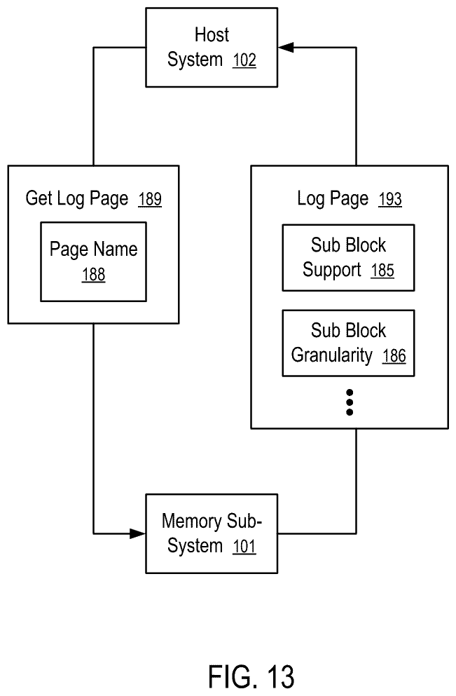

Alternatively, when the support for sub block descriptor is implemented as a vendor specific feature/enhancement of a device in compliance with a version of NVMe standard (e.g., base specification version 2.0), the sub block support 185 and the sub block granularity 186 can be provided via a vendor specific log page 193, as illustrated in FIG. 13.

In FIG. 13, the host system 102 can send, to the memory sub-system 101, a command of get log page 189. The command of get log page 189 can specify a page number 188 according to a NVMe standard to retrieve the vendor specific log page 193. If the memory sub-system 101 supports sub block access, the memory sub-system 101 can identify, in the vendor specific log page 193, the sub block support 185 and the sub block granularity 186.

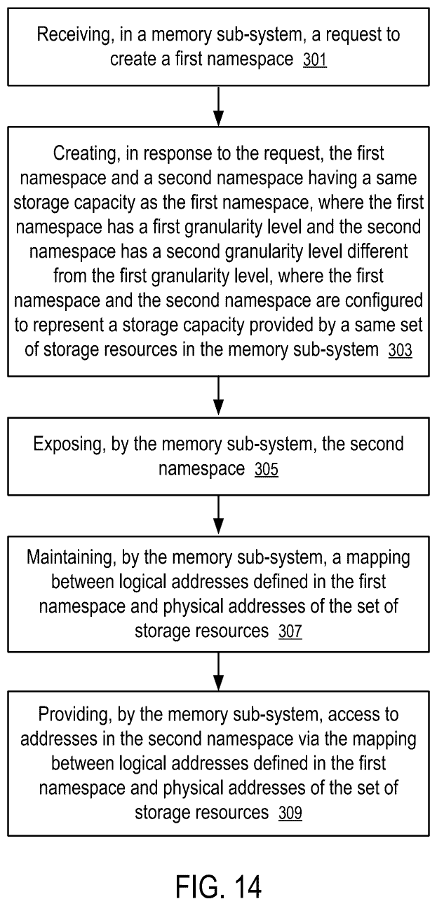

FIG. 14 to FIG. 16 show methods for sub block access according to some embodiments. The methods of FIG. 14 to FIG. 16 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the methods of FIG. 14 to FIG. 16 are performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the methods of FIG. 14 to FIG. 16 can be implemented using the sub block access managers 113 of FIG. 1 to perform the operations illustrated in FIG. 2 to FIG. 13.

At block 301, the method of FIG. 14 includes receiving, in a memory sub-system 101, a request to create a first namespace (e.g., 121).

At block 303, the method includes creating, in response to the request, the first namespace (e.g., 121) and a second namespace (e.g., 123) having a same storage capacity as the first namespace (e.g., 121). The first namespace (e.g., 121) has a first granularity level; and the second namespace (e.g., 123) has a second granularity level different from the first granularity level. The first namespace (e.g., 121) and the second namespace (e.g., 123) are configured to represent the same storage capacity provided by a same set of storage resources (e.g., blocks 131, . . . , 133) in the memory sub-system 101.

For example, a first size (e.g., 127) of a storage space (e.g., block 134) represented by each address (e.g., 126) in the first namespace (e.g., 121) is a multiple of a second size (e.g., 129) of a storage space (e.g., unit 135) represented by each address (e.g., 128) in the second namespace (e.g., 123).

For example, the first namespace (e.g., 121) is accessible via a first protocol 145; and the second namespace (e.g., 123) is accessible via a second protocol 147.

For example, the memory sub-system 101 is configured to operate according to a standard for non-volatile memory express (NVMe). The first protocol 145 can be a first NVMe command set (e.g., an NVMe block namespace command set); and the second protocol 147 can be a second NVMe command set (e.g., an NVMe memory namespace command set)

At block 305, the method includes exposing, by the memory sub-system 101, the second namespace (e.g., 123) so that the host system 102 may use the second namespace (e.g., 123) in an access request (e.g., 143).

At block 307, the method includes maintaining, by the memory sub-system 101, a mapping (e.g., address map 139) between logical addresses defined in the first namespace (e.g., 121) and physical addresses of the set of storage resources (e.g., blocks 131, . . . , 133).

At block 309, the method includes providing, by the memory sub-system 101, access to addresses (e.g., 128) in the second namespace (e.g., 123) via the mapping (e.g., address map 139) between logical addresses defined in the first namespace (e.g., 121) and physical addresses of the set of storage resources (e.g., 131, . . . , 133).

For example, the method of FIG. 14 can further include: receiving, in the memory sub-system 101, a request to access a first address (e.g., 128) in the second namespace 123; determining, by the memory sub-system 101, a second address (e.g., 126) in the first namespace 121 based on a ratio between the first size 127 and the second size 129; and accessing the first address (e.g., 128) in the second namespace (e.g., 123) based on the second address (e.g., 126) in the first namespace 121.

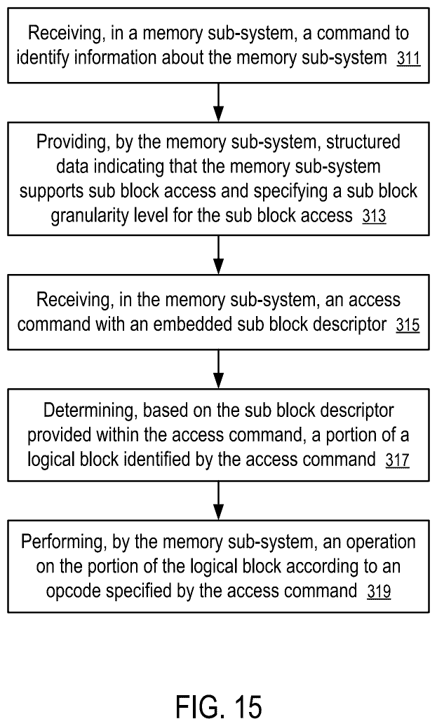

At block 311, the method of FIG. 15 includes receiving, in a memory sub-system 101, a command 187 to identify information about the memory sub-system 101.

At block 313, the method includes providing, by the memory sub-system 101, structured data (e.g., identify controller data 180) indicating that the memory sub-system 101 supports sub block access and specifying a level of sub block granularity 186 for the sub block access.

For example, the structured data (e.g., data 180) includes a field for scatter gather lists (SGL) support 184; and an indication (e.g., sub block support 185) that the memory sub-system supports the sub block access and the level of sub block granularity 186 are provided within the field for SGL support 184.

For example, the command 187 to identify information and the data structure are in accordance with a standard for non-volatile memory express (NVMe) (e.g., base specification version 2.0); the indication is provided in bit 22 of the field for SGL support 184; and the level of sub block granularity 186 is specified in bit 23 to bit 26 of the field for SGL support 184.

Alternatively, the structured data includes a field for vendor specific information; and an indication that the memory sub-system supports the sub block access and the sub block granularity level are provided within the field for vendor specific information (e.g., field vendor specific 191 in identify controller data structure 180).

The level of sub block granularity 186 provided in the identify controller data 180 allows a host system 102 to formulate a sub block descriptor 170 in accessing the memory sub-system at a level below the storage size 127 of logical block.

At block 315, the method includes receiving, in the memory sub-system 101, an access command 160 with a sub block descriptor 170 embedded within the access command 160.

For example, the sub block descriptor 170 specifies an offset 172 and a length 173; and the portion (e.g., unit 135) in the logical block 134 is determined based on the offset 172, the length 173, and the level of sub block granularity 186.

For example, the access command 160 is in accordance with a standard for non-volatile memory express (NVMe); and the sub block descriptor 170 is specified in a field of data pointer 166.

For example, the sub block descriptor 170 further specifies an identifier 174 of the sub block descriptor 170, including a type 175 and a sub type 176. The type can have a predetermined value of 6 h. The sub block descriptor has a predetermined size of 16 bytes; and the identifier 174 of the sub block descriptor 170 is configured in byte 15 of the sub block descriptor 170.

For example, the sub block descriptor 170 further specifies a memory address 171 to access a memory 106 of a host system 102 to transfer data from or to the portion (e.g., unit 135) of the logical block 134.

At block 317, the method includes determining, based on the sub block descriptor 170 provided within the access command 160, a portion (e.g., unit 135) of a logical block 134 identified by the access command 160.

At block 319, the method includes performing, by the memory sub-system 101, an operation on the portion (e.g., unit 135) of the logical block 134 according to an opcode 162 specified by the access command 160. For example, the opcode 162 can be a value representing a request to read data from the unit 135, or another value representing a request to write data to the unit 135.

For example, in a read operation, the memory sub-system 101 transfers the data, across the computer bus 107 between the memory sub-system 101 and the host system 102, from the portion (e.g., unit 135) of the logical block 134, without the data of the logical block 134 outside of the portion (e.g., unit 135).

For example, in a write operation, the memory sub-system 101 transfers the data, across the computer bus 107 between the memory sub-system 101 and the host system 102, from the memory 106 for the portion (e.g., unit 135) of the logical block 134, without the data of the logical block 134 outside of the portion (e.g., unit 135).

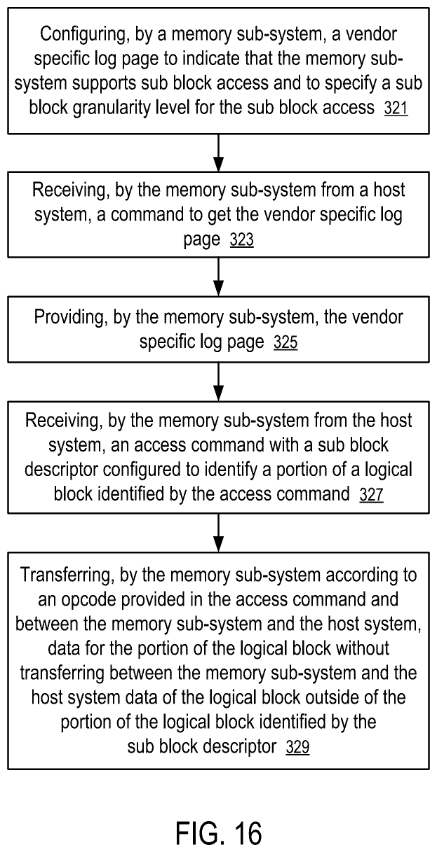

At block 321, the method of FIG. 16 includes configuring, by a memory sub-system 101, a vendor specific log page 193 to indicate that the memory sub-system 101 supports sub block access and to specify a level of sub block granularity 186 for the sub block access.

At block 323, the method includes receiving, by the memory sub-system 101 from a host system 102, a command to get the vendor specific log page 193.

At block 325, the method includes providing, by the memory sub-system 101, the vendor specific log page 193 to enable the host system 102 to correctly formulate a sub block descriptor 170 to access a portion (e.g., unit 135) within a logical block 134 represented by an LBA address 164.

At block 327, the method includes receiving, by the memory sub-system 101 from the host system 102, an access command 160 with a sub block descriptor 170 configured to identify a portion (e.g., unit 135) of a logical block 134 identified by the access command 160 (e.g., using the fields of namespace identifier 163 and LBA address 164).

For example, the sub block descriptor 170 is configured in a predetermined field (e.g., data pointer 166) which is operable to provide one of a plurality of descriptors (e.g., SGL descriptors) according to a standard for communications between memory sub-systems and host systems.

For example, the sub block descriptor 170 is not specified in the standard; and the standard is a standard for non-volatile memory express (NVMe).

For example, the sub block descriptor 170 specifies an offset 172 and a length 173; and the portion (e.g., unit 135) of the logical block 134 is determined based on the offset 172, the length 173, and a level of sub block granularity 186 specified in the log page 193.

For example, the sub block descriptor 170 can be specified in a field of data pointer 166 defined in an NVMe base specification.

For example, the sub block descriptor 170 further specifies an identifier 174 of the sub block descriptor 170, including a type 175 and a sub type 176. For example, the type has a predetermined value of 6 h; the sub block descriptor 170 has a predetermined size of 16 bytes; and the identifier 174 of the sub block descriptor 170 is configured in byte 15 of the sub block descriptor 170.

For example, the sub block descriptor further specifies a memory address 171 to access a memory 106 of a host system 102 to transfer data for the portion (e.g., unit 135) of the logical block 134.

At block 329, the method includes transferring, by the memory sub-system 101 according to an opcode 162 provided in the access command 160 and across a computer bus 107 between the memory sub-system 101 and the host system 102, data for the portion (e.g., unit 135) of the logical block 134, without transferring across the computer bus 107 between the memory sub-system 101 and the host system 102, data of the logical block 134 outside of the portion (e.g., unit 135) of the logical block 134 identified by the sub block descriptor 170.

For example, the access command 180 has a predetermined size with or without the sub block descriptor 170. When the access command 170 is embedded with the sub block descriptor 170, the data transfer between the memory sub-system 101 and the host system 102 is limited to the portion (e.g., unit 135). When the access command 170 does not have the sub block descriptor 170, the data transfer between the memory sub-system 101 and the host system 102 is for the entire logical block 134 without being limited to a portion (e.g., unit 135) of the logical block.

A non-transitory computer storage medium can be used to store instructions programmed to implement the sub block access managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

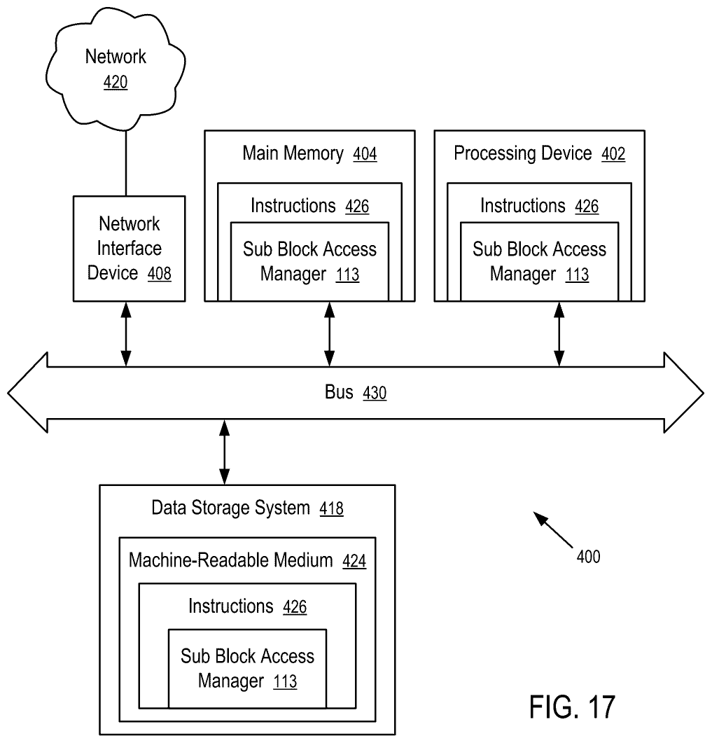

FIG. 17 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of sub block access managers 113 (e.g., to execute instructions to perform operations corresponding to the sub block access managers 113 described with reference to FIGS. 1-16). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the sub block access managers 113 described with reference to FIGS. 1-16. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
configuring, by a memory sub-system, a vendor specific log page to indicate that the memory sub-system supports sub block access and to specify a sub block granularity level for the sub block access;
receiving, by the memory sub-system from a host system, a command to get the vendor specific log page;
providing, by the memory sub-system, the vendor specific log page;
receiving, by the memory sub-system from the host system, an access command with a sub block descriptor configured to identify a portion of a logical block identified by the access command; and
transferring, by the memory sub-system according to an opcode provided in the access command and between the memory sub-system and the host system, data for the portion of the logical block without transferring between the memory sub-system and the host system data of the logical block outside of the portion of the logical block identified by the sub block descriptor.

2. The method of claim 1, wherein the access command has a predetermined size with or without the sub block descriptor.

3. The method of claim 2, wherein the sub block descriptor is configured in a predetermined field which is operable to provide one of a plurality of descriptors according to a standard for communications between memory sub-systems and host systems.

4. The method of claim 3, wherein the sub block descriptor is not specified in the standard; and the standard is a standard for non-volatile memory express (NVMe).

5. The method of claim 4, wherein the sub block descriptor specifies an offset and a length; and the portion is determined based on the offset, the length, and a sub block granularity level.

6. The method of claim 5, wherein the sub block descriptor is specified in a field of data pointer.

7. The method of claim 6, wherein the sub block descriptor further specifies an identifier of the sub block descriptor, including a type and a sub type.

8. The method of claim 7, wherein the type has a predetermined value of 6 h; the sub block descriptor has a predetermined size of 16 bytes; and the identifier of the sub block descriptor is configured in byte 15 of the sub block descriptor.

9. The method of claim 8, wherein the sub block descriptor further specifies a memory address to access a memory of a host system to transfer data for the portion of the logical block.

10. A memory sub-system, comprising:
a host interface configured to operate on a computer bus;
non-volatile memory cells; and
a controller configured to:
store, in a vendor specific log page, data indicating that the memory sub-system supports sub block access and providing a sub block granularity level for the sub block access;
receive, from a host system, a command to get the vendor specific log page;
provide the vendor specific log page;
receive, from the host system, an access command with a sub block descriptor configured to identify a portion of a logical block identified by the access command; and
transfer, over the computer bus according to an opcode provided in the access command, data for the portion of the logical block without transferring over the computer bus data of the logical block outside of the portion of the logical block identified by the sub block descriptor.

11. The memory sub-system of claim 10, wherein the access command has a predetermined size with or without the sub block descriptor.

12. The memory sub-system of claim 11, wherein the sub block descriptor is configured in a predetermined field which is operable to provide one of a plurality of descriptors according to a standard for communications between memory sub-systems and host systems.

13. The memory sub-system of claim 12, wherein the sub block descriptor is not specified in the standard; and the standard is a standard for non-volatile memory express (NVMe).

14. The memory sub-system of claim 13, wherein the sub block descriptor specifies an offset and a length; and the portion is determined based on the offset, the length, and a sub block granularity level.

15. The memory sub-system of claim 14, wherein the sub block descriptor is specified in a field of data pointer.

16. The memory sub-system of claim 15, wherein the sub block descriptor further specifies an identifier of the sub block descriptor, including a type and a sub type.

17. The memory sub-system of claim 16, wherein the type has a predetermined value of 6 h; the sub block descriptor has a predetermined size of 16 bytes; and
the identifier of the sub block descriptor is configured in byte 15 of the sub block descriptor.

18. The memory sub-system of claim 17, wherein the sub block descriptor further specifies a memory address to access a memory of a host system to transfer data for the portion of the logical block.

19. A non-transitory computer storage medium storing instructions which, when executed in a memory sub-system, cause the memory sub-system to perform a method, comprising:
receiving, in the memory sub-system over a computer bus from a host system, an access command with a sub block descriptor;
identifying, by the memory sub-system based on the sub block descriptor, a portion of a logical block identified by the access command; and
transferring, by the memory sub-system according to an opcode provided in the access command and over the computer bus, data of the portion of the logical block without transferring, over the computer bus, data of the logical block outside of the portion of the logical block identified by the sub block descriptor.

20. The non-transitory computer storage medium of claim 19, wherein the method further comprises:
storing, in a vendor specific log page, data to indicate that the memory sub-system supports sub block access and to specify a sub block granularity level for the sub block access;
receiving, in the memory sub-system and from the host system, a command to get the vendor specific log page; and
providing, by the memory sub-system, the vendor specific log page.
